(19) United States
(12) Patent Application Publication
(10) Pub. No.: US 2010/0020632 A1
(43) Pub. Date: Jan. 28, 2010

(54) Apparatus And Method for Mixing by Producing Shear, Turbulence and/or Cavitation

(75) Inventor: Francesc Corominas, Grimbergen (BE)

Correspondence Address: THE PROCTER & GAMBLE COMPANY;Global Legal Department - IP, Sycamore Building - 4th Floor, 299 East Sixth Street, CINCINNATI, OH, 45202, US

(73) Assignee: The Procter & Gamble Company, Cincinnati, OH (US)

(21) Appl. No.: 12/508,113

(22) Filed: Jul. 23, 2009

Related U.S. Application Data
(60) Provisional application No. 61/083,583, filed on Jul. 25, 2008.

(51) Int. Cl. B01F 15/02

(52) U.S. Cl. 366/173.1

(57) ABSTRACT

An apparatus and method for mixing liquid(s) by producing shear, turbulence and/or cavitation, and components for the apparatus are disclosed.

### FIELD OF THE INVENTION

The present invention is directed to an apparatus and method for mixing by producing shear, turbulence and/or cavitation, that requires lower input pressures to achieve the same degree of mixing as seen with alternative shear, turbulence and/or cavitation apparatuses already known in the art.

### BACKGROUND OF THE INVENTION

Cavitation refers to the process of forming vapor bubbles in a liquid. This can be done in a number of manners, such as through the use of a swiftly moving solid body (as an impeller), hydrodynamically, or by high-frequency sound waves. When the bubbles collapse further downstream from the forming location, they release a certain amount of energy, which can be utilized for making chemical or physical transformations.

One particular apparatus for producing hydrodynamic cavitation is known as a liquid whistle. Liquid whistles are described in Chapter 12 “Techniques of Emulsification” of a book entitled Emulsions—Theory and Practice, 3^{rd} Ed., Paul Becher, American Chemical Society and Oxford University Press, NY, N.Y., 2001. An example of a liquid whistle is a SONOLATOR® high pressure homogenizer, which is manufactured by Sonic Corp. of Stratford, Conn., U.S.A. The liquid whistle directs liquid under pressure through an orifice into a chamber having a knife-like blade therein. The liquid is directed at the blade, and the action of the liquid on the blade causes the blade to vibrate at audible or ultrasonic frequencies. Hydrodynamic cavitation is produced in the liquid in the chamber downstream of the orifice.

Liquid whistles have been in use for many years, and have been used as in-line systems, single or multi-feed, to instantly create fine, uniform and stable emulsions, dispersions, and blends in the chemical, personal care, pharmaceutical, and food and beverage industries.

It has been found, however, that improvements to such devices may be desirable. Current liquid whistle apparatuses require the liquid(s) intending to be mixed, to enter the liquid whistle under very high operating pressures, in some cases up to 1000 bar. By operating pressure, it is understood to mean the pressure of the liquid(s) as it enters the liquid whistle device. This ensures efficient mixing of the liquids within the apparatus. However, achieving such high pressures is expensive, energy consuming, and requires the use of large bulky equipment, such as the Sonolator® 8 High Pressure Homogenizer. Another problem with such high pressures is that they can cause erosion of components within the mixing device. This is usually due to mechanical wear caused by the high pressure liquids, but can also be exacerbated by the chemical properties of the liquid(s) being mixed.

There is a need in the art for improvements to apparatuses for mixing liquids by producing shear, turbulence and/or cavitation, such that lower pressures can be used, yet the same degree of mixing can still be achieved as is seen with alternative high pressure apparatuses.

There is also a need in the art to minimize the erosion of internal components of high pressure mixing apparatuses.

It was surprisingly found that the apparatus of the present invention, which comprises two or more orifices arranged in series, achieved a comparable degree of mixing as is seen with known shear and/or cavitation mixing apparatuses, but required decreased pressures than are normally required.

### SUMMARY OF THE INVENTION

A first aspect of the present invention is an apparatus 100 for mixing liquids by producing shear, turbulence and/or cavitation, said apparatus comprising: at least one inlet 1A;
a pre-mixing chamber 2, the pre-mixing chamber having an upstream end 3 and a downstream end 4, the upstream end 4 of the pre-mixing chamber 2 being in liquid communication with the at least one inlet 1A;
an orifice component 5, the orifice component having an upstream end 6 and a downstream end 7, the upstream end 6 of the orifice component 5 being in liquid communication with the downstream end 4 of the pre-mixing chamber 2, wherein the orifice component 5 is configured to spray liquid in a jet and produce shear, turbulence and/or cavitation in the liquid;
a secondary mixing chamber 8, the secondary mixing chamber 8 being in liquid communication with the downstream end 7 of the orifice component 5;
at least one outlet 9 in liquid communication with the secondary mixing chamber 8 for discharge of liquid following the production of shear, turbulence and/or cavitation in the liquid, the at least one outlet 9 being located at the downstream end of the secondary mixing chamber 8;
   wherein;
the orifice component 5 comprises at least two orifice units 10 and 11 arranged in series to one another;
wherein each orifice unit comprises an orifice plate 12 comprising at least one orifice 13, an orifice chamber 14 located upstream from the orifice plate 12 and in liquid communication with the orifice plate 12;
and wherein neighbouring orifices plates are distinct from each other.

A second aspect of the present invention is a process for mixing liquids by producing shear, turbulence and/or cavitation, using the apparatus 100 of any preceding claims, comprising the steps of;
introducing at least one liquid to the inlet 1A of the apparatus 100 at an operating pressure of between 0.1 bar and 50 bar;
allowing the liquid to pass through the apparatus 100;
discharging the liquid following the production of shear or cavitation in the liquid, out of the outlet 9.

### BRIEF DESCRIPTION OF THE DRAWINGS

FIG. 1 details the apparatus 100 of the present invention.

FIG. 2 details the orifice component 5 of the present invention.

### DETAILED DESCRIPTION OF THE INVENTION

In the context of the present invention, the terms “a” and “an” mean at “at least one”.

When describing the “two orifices” or “two orifice units” of the present invention, we herein mean “at least two orifices” or “at least two orifice units”.

By “shear” we herein mean, a strain produced by pressure in the structure of a substance, when its layers are laterally shifted in relation to each other.

By “turbulence” we herein mean, the irregular and disordered flow of fluids.

By “cavitation” we herein mean, the formation of bubbles in a liquid due to the hydrodynamics of the liquid and the collapsing of those bubbles further downstream.

By “operating pressure” we herein mean the pressure of the liquid(s) as they enter the at least one inlet 1A.

The present invention is directed to an apparatus and method for mixing by producing shear, turbulence and/or cavitation. It should be understood that, in certain embodiments, the ability of the apparatus and method to induce shear may not only be useful for mixing, but may also be useful for dispersion of solid particles in liquids, liquid in liquid dispersions and in breaking up solid particles. In certain embodiments, the ability of the apparatus and method to induce shear and/or produce cavitation may also be useful for droplet and/or vesicle formation.

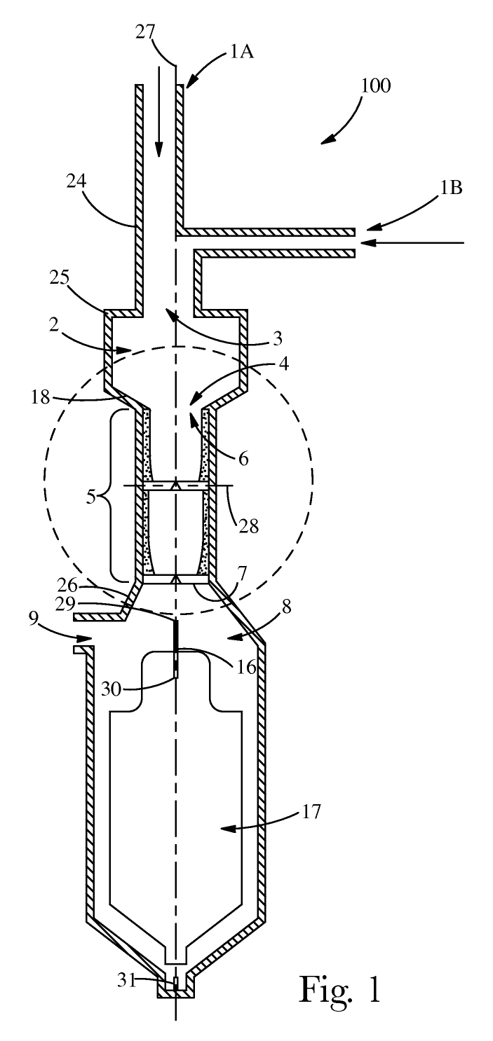

FIG. 1 shows one non-limiting embodiment of an apparatus 100 for mixing liquids by producing shear, turbulence and/or cavitation, said apparatus comprising, at least one inlet 1A and a pre-mixing chamber 2. The pre-mixing chamber has an upstream end 3 and a downstream end 4, the upstream end 4 being in liquid communication with the at least one inlet 1A. The apparatus 100 also comprises an orifice component 5, the orifice component 5 having an upstream end 6 and a downstream end 7. The upstream end of the orifice component 6 is in liquid communication with the downstream end 4 of the pre-mixing chamber 2, and the orifice component 5 is configured to spray liquid in a jet and produce shear or cavitation in the liquid. A secondary mixing chamber 8 is in liquid communication with the downstream end 7 of the orifice component 5. At least one outlet 9 communicates with the secondary mixing chamber 8 for discharge of liquid following the production of shear, turbulence or cavitation in the liquid, and is located at the downstream end of the secondary mixing chamber 8.

A liquid(s) can be introduced into the inlet 1A at a desired operating pressure. The liquid can be introduced at a desired operating pressure using standard liquid pumping devices. The liquid flows from the inlet into the pre-mix chamber 2 and then into the orifice component 5. The liquid will then exit the orifice component 5 into the secondary mixing chamber 8, before exiting the apparatus 100 through the outlet 9.

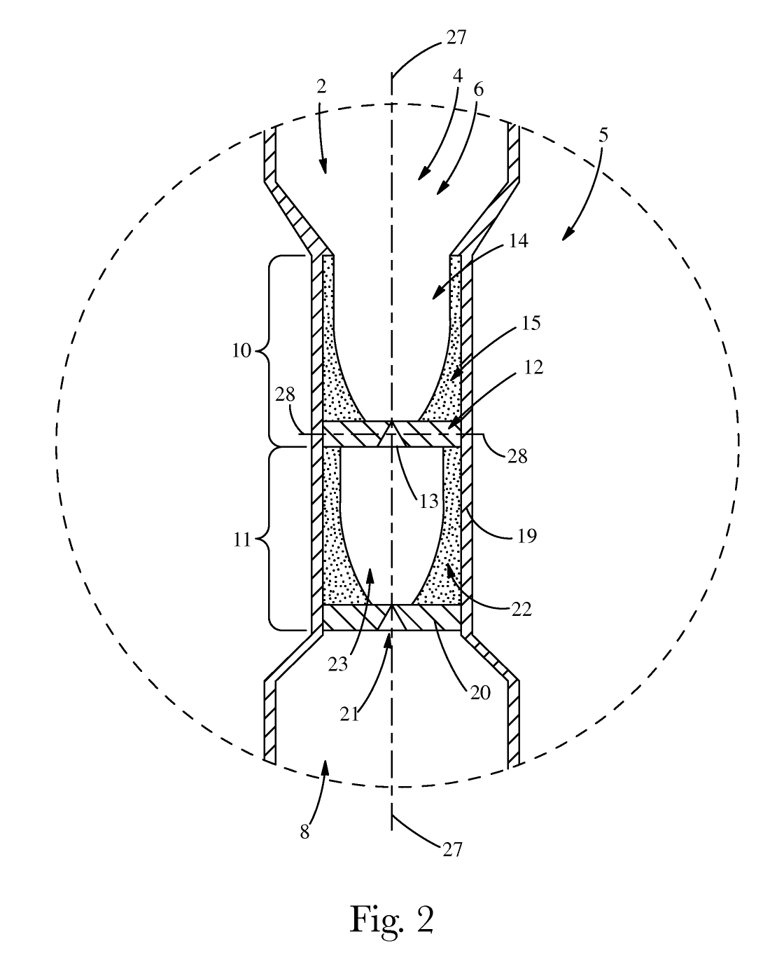

As can be seen in FIG. 2, the orifice component comprises at least two orifice units 10 and 11 arranged in series to one another. Each orifice unit comprises an orifice plate 12 comprising at least one orifice 13, an orifice chamber 14 located upstream from the orifice plate and in liquid communication with the orifice plate. In one embodiment, the orifice unit 10 further comprises an orifice bracket 15 located adjacent to and upstream from the orifice plate 12, the walls of the orifice bracket 15 defining a passageway through the orifice chamber 14.

In another embodiment, the apparatus 100 comprises at least 5 orifice units arranged in series. In yet another embodiment, the apparatus 100 comprises at least 10 orifice units arranged in series.

The apparatus 100 may, but need not, further comprise at least one blade 16, such as a knife-like blade, disposed in the secondary mixing chamber 8 opposite the orifice component 5.

The components of the present apparatus 100 can include an injector component, an inlet housing 24, a pre-mixing chamber housing 25, an orifice component housing 19, the orifice component 5, a secondary mixing chamber housing 26, a blade holder 17, and an adjustment component 31 for adjusting the distance between the tip of blade 16 and the discharge of the orifice component 5. It may also be desirable for there to be a throttling valve (which may be external to the apparatus 100) that is located downstream of the secondary mixing chamber 8 to vary the pressure in the secondary mixing chamber 8. The inlet housing 24, pre-mixing chamber housing 25, and secondary mixing chamber housing 26 can be in any suitable configurations. Suitable configurations include, but are not limited to cylindrical, configurations that have elliptical, or other suitable shaped cross-sections. The configurations of each of these components need not be the same. In one embodiment, these components generally comprise cylindrical elements that have substantially cylindrical inner surfaces and generally cylindrical outer surfaces.

These components can be made of any suitable material(s), including but not limited to stainless steel, AL6XN, Hastalloy, and titanium. It may be desirable that at least portions of the blade 16 and orifice component 5 to be made of materials with higher surface hardness or higher hardnesses. Suitable materials with higher surface hardness or higher hardnesses are described in provisional U.S. Patent Application Ser. No. 60/937,501, filed Jun. 28, 2007. The components of the apparatus 100 can be made in any suitable manner, including but not limited to, by machining the same out of solid blocks of the materials described above. The components may be joined or held together in any suitable manner.

The various elements of the apparatus 100 as described herein, are joined together. The term “joined”, as used in this specification, encompasses configurations in which an element is directly secured to another element by affixing the element directly to the other element; configurations in which the element is indirectly secured to the other element by affixing the element to intermediate member(s) which in turn are affixed to the other element; configurations where one element is held by another element; and configurations in which one element is integral with another element, i.e., one element is essentially part of the other element. In certain embodiments, it may be desirable for at least some of the components described herein to be provided with threaded, clamped, or pressed connections for joining the same together. One or more of the components described herein can, for example, be clamped, held together by pins, or configured to fit within another component.

The apparatus 100 comprises at least one inlet 1A, and typically comprises two or more inlets, such as inlets 1A and 1B, so that more than one material can be fed into the apparatus 100. The apparatus 100 can comprise any suitable number of inlets so that any of such numbers of different materials can be fed into the apparatus 100. In another embodiment, a pre-mix of two liquids can be introduced into just one inlet of the apparatus 100. This pre-mix is then subjected to shear, turbulence and/or cavitation as it is fed through the apparatus 100.

The apparatus 100 may also comprise at least one drain, or at least one dual purpose, bidirectional flow conduit that serves as both an inlet and drain. The inlets and any drains may be disposed in any suitable orientation relative to the remainder of the apparatus 100. The inlets and any drains may, for example, be axially, radially, or tangentially oriented relative to the remainder of the apparatus 100. They may form any suitable angle relative the longitudinal axis of the apparatus 100. The inlets and any drains may be disposed on the sides of the apparatus. If the inlets and drains are disposed on the sides of the apparatus, they can be in any suitable orientation relative to the remainder of the apparatus.

In one embodiment the apparatus 100 comprises one inlet 1A in the form of an injector component that is axially oriented relative to the remainder of the apparatus. The injector component comprises an inlet for a first material.

A first liquid can be introduced into the apparatus 100 through inlet 1A. The first liquid can comprise any suitable liquid or gas. In some embodiments, it may be desirable for the first liquid to comprise two or more different phases, or multiple phases. The different phases can comprise one or more liquid, gas, or solid phases. In the case of liquids, it is often desirable for the liquid to contain sufficient dissolved gas for cavitation. Suitable liquids include, but are not limited to water, oil, solvents, liquefied gases, slurries, and melted materials that are ordinarily solids at room temperature. Melted solid materials include, but are not limited to waxes, organic materials, inorganic materials, polymers, fatty alcohols, and fatty acids.

The first liquid can also have solid particles therein. The particles can comprise any suitable material. The particles can be of any suitable size, including macroscopic particles and nanoparticles. These particles may be present in any suitable amount in the first liquid.

The apparatus 100 also comprises a second inlet 1B. The second inlet 1B can be used to introduce an additional stream of the first liquid into the apparatus, or it can be used to introduce a second liquid into the apparatus. If a second liquid is fed into the apparatus, the second liquid may comprise any of the general types of materials described in conjunction with the first liquid. The second liquid may also be heated or unheated. The liquids can be supplied to the apparatus 100 in any suitable manner including, but not limited to through the use of pumps and motors powering the same. The pumps can supply the liquids to the apparatus 100 under the desired operating pressure.

The operating pressure of conventional shear, turbulence and/or cavitation apparatuses is between about 6.9 bar and 690 bar. The preferred operating pressure of the present invention is lower, yet the same degree of liquid mixing is achievable as seen with conventional apparatuses. In one embodiment, the apparatus 100 has an operating pressure between 0.1 bar and 50 bar. In another embodiment the operating pressure of the apparatus 100 is between 0.25 bar and 20 bar. In yet another embodiment, the operating pressure of the apparatus 100 is between 0.5 bar and 10 bar. It should be noted that the apparatus 100 can also, if desired, be operated at the higher pressures (up to 690 bar) seen with conventional apparatuses.

In one embodiment, the apparatus 100 further comprises at least one drain or dual purpose, bidirectional flow conduit that can serve as both an inlet and drain. In this embodiment, the second inlet 1B, the combination inlet/drain, and the injector component, can comprise high pressure connections so that the materials can be fed into the apparatus 100 under high pressure, such as by high pressure pumps. The inlets may, for example, comprise connections that are capable of handling liquid under pressures of between about 6.9 bar and 690 bar or more, or alternatively between about 13.8 bar and 345 bar. In this embodiment, the second inlet 1B and the combination inlet/drain are arranged in an opposing configuration, and are respectively located on the gravitational top and bottom of the apparatus 100. This provides better drainability of the apparatus 100 when cleaning the apparatus.

The pre-mixing chamber 2 has an upstream end 3, a downstream end 4, and interior walls. In certain embodiments, it may further be desirable for at least a portion of the pre-mixing chamber 2 to be provided with an initial axially symmetrical constriction zone 18 that is tapered (prior to the location of the downstream end of the injector) so that the size (e.g. diameter) of the upstream mixing chamber 2 becomes smaller toward the downstream end 4 of the pre-mixing chamber 2 as the orifice component 5 is approached.

In some embodiments, it is desirable for the apparatus 100 described herein to be substantially free of liquid baffles or turning vanes in the path of liquid into the orifice component 5 so that the apparatus 100 will be easier to clean. In alternative embodiments, baffles or turning vanes can be used to create axially symmetric flow.

The orifice component 5 can be in any suitable configuration. In some embodiments, the orifice component 5 can comprise a single component. In other embodiments, the orifice component 5 can comprise one or more components of an orifice component system. One non-limiting embodiment of an orifice component 5 system is shown in greater detail in FIG. 2.

The apparatus comprises an orifice component 5, wherein the orifice component comprises at least a first orifice unit 10 and a second orifice unit 11.

In the embodiment shown in FIG. 2 the orifice component 5 comprises an orifice component housing 19. The first orifice unit 10 comprises a first orifice plate 12 comprising a first orifice 13 and a first orifice chamber 14. In one embodiment, the first orifice unit 10 further comprises a first orifice bracket 15. The second orifice unit 11 also comprises a second orifice plate 20 comprising a second orifice 21, a second orifice chamber 23 and optionally a second orifice bracket 22. Looking at these components in greater detail, the orifice component housing 19 is a generally cylindrically-shaped component having side walls and an open upstream end 6, and a substantially closed (with the exception of the opening for the second orifice 21) downstream end 7.

Looking now at the first orifice unit 10, the orifice chamber 14 is located upstream from, and in liquid communication with, the orifice plate 12. The first orifice bracket 15 is sized and configured to fit inside the orifice component housing 9 adjacent to, and upstream of, the first orifice plate 12 to hold the first orifice plate 12 in place within the orifice component housing 9. The first orifice bracket 15 has interior walls which define a passageway through the first orifice chamber 14.

The second orifice unit 11 is substantially the same construction as the first orifice unit 10.

The orifice units 10 and 11 are arranged in series within the orifice component 5. Any number of orifice units can be arranged in series within the orifice component 5. Each orifice plate can comprise at least one orifice. The orifices can be arranged anywhere upon the orifice plate, providing they allow the flow of liquids through the apparatus 100. Each orifice plate can comprise at least one orifice arranged in a different orientation than the next orifice plate. In one embodiment, each orifice plate comprises at least one orifice that is arranged so that it is off-centered as compared to the orifice in the neighbouring orifice plate. In one embodiment, the size of the orifice within the orifice plate can be adjusted in situ to make it bigger or smaller, i.e. without changing or removing the orifice plate.

The first orifice bracket 15 and second orifice bracket 22, can be of any suitable shape or size, providing they secure the first orifice plates during operation of the apparatus 100. FIGS. 1 and 2 show a non-limiting example of the orientation and size of an orifice bracket 22. In another embodiment, the orifice bracket 22 may extend only half the distance between the second orifice plate 20 and the first orifice plate 12. In yet another embodiment, the second orifice bracket 22 may extend only a quarter of the distance between the second orifice plate 20 and the first orifice plate 12.

In one embodiment, the orifice plate 12 is hinged so that it can be turned 90° about its central axis. The central axis can be any central axis, providing it is perpendicular to the centre-line 27, which runs along the length of the apparatus 100. In one embodiment, the central-axis can be along the axis line 28. By allowing the orifice 12 to be moved 90° about its central axis, build up of excess material in the first orifice chamber 14 and/or second orifice chamber 23 can be more readily removed. In one embodiment, the size and/or orientation of the first orifice bracket 15 can be adjusted to allow the rotation of the first orifice plate 12. For example, in one embodiment, the first orifice bracket 15 can be unsecured and moved in an upstream direction away from the first orifice plate 12 towards the pre-mixing chamber 2. The orifice plate 12 can then be unsecured and rotated through 90°. Once the apparatus 100 is clean, the first orifice plate 12 can be returned to its original operating configuration and then if present, the first orifice bracket 15 returned to its original operating position. The second orifice plate 20 and also any extra orifice plates present, may also be hinged. The second orifice bracket 22 and any other orifice brackets present may also be adjustable in the manner as described for the first orifice bracket 15.

Any two orifice plates must be distinct from one another. In other words neighbouring orifice plates must not be touching. By “neighbouring”, we herein mean the next orifice plate in series. If two neighbouring plates are touching, mixing of liquids between orifices is not achievable. In one embodiment, the distance between the first orifice plate 12 and the second orifice plate 20 is equal to or greater than 1 mm.

The elements of the orifice component 5 form a channel defined by walls having a substantially continuous inner surface. As a result, the orifice component 5 has few, if any, crevices between elements and may be easier to clean than prior devices. Any joints between adjacent elements can be highly machined by mechanical seam techniques, such as electro polishing or lapping such that liquids cannot enter the seams between such elements even under high pressures.

The orifice component 5, and the components thereof, can be made of any suitable material or materials. Suitable materials include, but are not limited to stainless steel, tool steel, titanium, cemented tungsten carbide, diamond (e.g., bulk diamond) (natural and synthetic), and coatings of any of the above materials, including but not limited to diamond-coated materials.

The orifice component 5, and the elements thereof, can be formed in any suitable manner. Any of the elements of the orifice component 5 can be formed from solid pieces of the materials described above which are available in bulk form. The elements may also be formed of a solid piece of one of the materials specified above, which may or may not be coated over at least a portion of its surface with one or more different materials specified above. Since the apparatus 100 requires lower operating pressures than other shear, turbulence and/or cavitation devices, it is less prone to erosion of its internal elements due to mechanical and/or chemical wear at high pressures. This means that it may not require expensive coating, such as diamond-coating, of its internal elements.

In other embodiments, the orifice component 5 with the first orifice 13 and the second orifice 21 therein can comprise a single component having any suitable configuration, such as the configuration of the orifice component shown in FIG. 2. Such a single component could be made of any suitable material including, but not limited to, stainless steel. In other embodiments, two or more of the elements of the orifice component 5 described above could be formed as a single component.

The first orifice 13 and second orifice 21 are configured, either alone, or in combination with some other component, to mix the fluids and/or produce shear, turbulence and/or cavitation in the fluid(s), or the mixture of the fluids. The first orifice 13 and second orifice 21 can each be of any suitable configuration. Suitable configurations include, but are not limited to slot-shaped, eye-shaped, cat eye-shaped, elliptically-shaped, triangular, square, rectangular, in the shape of any other polygon, or circular.

The blade 16 has a front portion comprising a leading edge 29, and a rear portion comprising a trailing edge 30. The blade 16 also has an upper surface, a lower surface, and a thickness, measured between the upper and lower surfaces. In addition, the blade 16 has a pair of side edges and a width, measured between the side edges.

The blade 16 can have any suitable configuration. The blade 16 can comprise a tapered portion in which the thickness, of the blade increases from the leading edge 29 in a direction from the leading edge toward the trailing edge 30 along a portion of the distance between the leading edge 29 and the trailing edge 30. In one embodiment, the blade 16 has a single tapered or sharpened edge forming its leading edge 29. The leading edge 29 of the blade 16 may be sharpened, but in other embodiments, it need not be sharpened. It should be understood that in other embodiments, the blade 16 may have two, three, or four or more tapered or sharpened edges so that the blade 16 can be inserted into the apparatus 100 with any of the sharpened edges oriented to form the leading edge 29 of the blade 16. The blade 16 can have any suitable dimensions.

As shown in FIG. 1, when the blade 16 is inserted into the apparatus 100, a portion of the rear portion of the blade 16 is clamped, or otherwise joined inside the apparatus so that its position is fixed. The blade 16 can be configured in any suitable manner so that it can be joined to the inside of the apparatus.

The blade 16 can comprise any suitable material or materials. The blade 16 desirably will comprise a material, or materials, that are chemically compatible with the fluids to be processed. Suitable materials for the blade 16 include, but are not limited to any material or materials described herein as being suitable for use in the orifice component 5, and the components thereof. It should be understood, however, that the materials specified herein do not necessarily have all of the desired chemical resistance properties.

As shown in FIG. 1, in some embodiments, the apparatus 16 may comprise a blade holder 17.

The apparatus 100 comprises at least one outlet or discharge port 9.

The apparatus 100 may comprise one or more extra inlets. These extra inlets can be positioned anywhere on the apparatus 100 and may allow for the addition of extra liquids. In one embodiment, the second orifice unit comprises an extra inlet. In another embodiment, the secondary mixing chamber comprises an extra inlet. This allows for the addition of an extra liquid to be added to liquids that have exited the orifice component 5.

It is also desirable that the interior of the apparatus 100 be substantially free of any crevices, nooks, and crannies so that the apparatus 100 will be more easily cleanable between uses. In one embodiment of the apparatus 100 described herein, the orifice component 5 comprises several elements that are formed into an integral structure. This integral orifice component 5 structure fits as a unit into the pre-mixing chamber housing and requires no backing block to retain the same in place, eliminating such crevices.

Numerous other embodiments of the apparatus 100 and components therefor are possible as well. The blade holder 17 could be configured to hold more than one blade 16. For example, the blade holder 17 could be configured to hold two or more blades.

A process for mixing by producing shear, turbulence and/or cavitation in a liquid is also contemplated herein. The process utilizes an apparatus 100 such as that described above. The process comprises introducing at least one liquid into the pre-mixing chamber 2 so that the liquid passes through the orifice component 5. The at least one liquid can be supplied to the apparatus 100 in any suitable manner including, but not limited to, through the use of pumps and motors powering the same. The pumps can supply at least one liquid to the apparatus under the desired pressure through inlets 1A and 1B. The liquid(s), or the mixture of the liquids, pass through the orifice component 5 under pressure. Any suitable pressure may be used. In one embodiment, the apparatus 100 has an operating pressure between 0.1 bar and 50 bar. In another embodiment the operating pressure of the apparatus 100 is between 0.25 bar and 20 bar. In yet another embodiment, the operating pressure of the apparatus 100 is between 0.5 bar and 10 bar. The orifice component 5 is configured, either alone, or in combination with some other component, to mix the liquids and/or produce shear, turbulence and/or cavitation in the liquid(s), or the mixture of the liquids.

The process may further comprise providing a blade, such as blade 16, disposed in the secondary mixing chamber 8 opposite the orifice component 5. In cases where a blade 16 is used, the process may include a step of forming the liquid into a jet stream and impinging the jet stream against the vibratable blade with sufficient force to induce the blade to vibrate harmonically at an intensity that is sufficient to generate cavitation in the liquid. The cavitation may be hydrodynamic or acoustic.

A given volume of liquid can have any suitable residence time and/or residence time distribution within the apparatus 100. Some suitable residence times include, but are not limited to from about 1 microsecond to about 1 second, or more. The liquid(s) can flow at any suitable flow rate through the apparatus 100. Suitable flow rates range from about 1 to about 1,500 L/minute, or more, or any narrower range of flow rates falling within such range including, but not limited to from about 5 to about 1,000 L/min.

The process may be used to make many different kinds of products including, but not limited to surfactants, emulsions, dispersions, and blends in the chemical, household care, personal care, pharmaceutical, and food and beverage industries.

### EXAMPLES

The following examples demonstrate how the apparatus 100 of the present invention achieves the same degree of mixing of liquids as alternative high pressure apparatuses known in the art, but utilizes lower operating pressures than these alternative apparatuses. In the context of high shear, turbulence and/or cavitation mixing devices, the extent of a dispersion or emulsification can be assessed by a comparison of mean particle size, or mean particle size distribution. High shear, turbulence and/or cavitation mixing devices produce dispersion and/or emulsion compositions that comprise particles, these particles having a range of sizes. It is desirable to achieve a particular mean particle size, which requires a particular operating pressure. It is also desirable to achieve a particular particle size distribution. Generally, if a higher percentage of smaller particles are required, a higher operating pressure is necessary.

### Example 1

Two liquids were fed into the apparatus 100, each through a separate inlet. The first liquid was a molten cationic surfactant (100% molten diethyl ester dimethyl ammonium chloride) composition. The second liquid was water. The final composition produced was 6% cationic surfactant, 94% water.

The same composition was fed into a Sonolator® 8 High Pressure Homogenizer, again as two separate feeds. The orifice in the Sonolator was 1.1 mm².

Both devices were used with an operating pressure of 4 bar +/−0.2 bar, as measured using an Ashcroft pressure meter using standard techniques known in the art. The flow rate was maintained at 5 kg/min +/−0.25 kg/min, as measured by an Endress & Hauser Promass M flowmeter using standard techniques known in the art.

The apparatus of the present invention was prepared with 4 orifice plates, each spaced 12 mm from the neighbouring plate. Each plate comprised one circular orifice having a diameter of 1.9 mm. The orifices were aligned with each other along the centre-line 27 of the apparatus 100.

TABLE 1

| | Sonolator 8 | Apparatus 100 |
|---|---|---|
| Viscosity at 1 s⁻¹ (mPa s) | 20 | 14 |
| Mean Particle size (nm) | 219 | 177 |

As can be seen from Table 1, at 4 bar pressure, the apparatus 100 produced a smaller mean particle size as measured using a Malvern Zeta Sizer Nano-ZS Particle Size Distribution Analyzer (sample was diluted 100 times before measurement) using a standard Malvern Zeta Sizer measuring cell; this being indicative of better liquid-liquid dispersion than the Sonolator 8 at the same pressure. The apparatus of the present invention also produced a composition having a lower viscosity as measured using a Anton Paar Rheometer at 21° C., using a “bob and cup” concentric cylinder measuring system; specifically, an Anton Paar CC27 (27 mm diameter) bob and an Anton Paar CC27 stainless steel cup, using standard techniques known in the art.

A person skilled in the art will recognize that, in the case of a vesicular dispersion as the one achieved in Example 1, the smaller the particle size, the lower the viscosity of the dispersion.

### Example 2

Two liquids were fed into the apparatus 100, each through a separate inlet. The first liquid was a molten cationic surfactant (100% molten diethyl ester dimethyl ammonium chloride) composition. The second liquid was water. The final composition produced was 10% cationic surfactant, 90% water.

The same composition was fed into a Sonolator® 8 High Pressure Homogenizer, again as two separate feeds. The orifice in the Sonolator was 0.65 mm².

The operating pressure required to produce a composition comprising a particle size population having 95% of particles below 0.2 μm in size was measured using an Ashcroft pressure meter using standard techniques known in the art. This was repeated for compositions having a particle size population having 95% of particles below 0.5 μm, and lastly below 1.0 μm.

The apparatus of the present invention was prepared with 5 orifice plates, each spaced 15 mm from the neighbouring plate. Each plate comprised one circular orifice having a diameter of 1.9 mm. The orifices were aligned with each other along the centre-line 27 of the apparatus 100.

TABLE 2

| | Pressure needed | Pressure needed | Pressure needed |
|---|---|---|---|
| | to achieve 95% of | to achieve 95% of | to achieve 95% of |
| | the population | the population | the population |
| | below 0.2 μm. | below 0.5 μm. | below 1.0 μm. |
| Sonolator 8 | 50 bar | 20 bar | 8 bar |
| Apparatus 100 | 15 bar | 5 bar | 2 bar |

Samples were diluted 100 times and particle size distribution measured using a Horiba LA-920. Laser Scattering Particle Size Distribution Analyzer using standard techniques known in the art.

As can be seen from Table 2, the apparatus 100 uses a lower pressure to achieve a given desired particle size distribution than the Sonolator® 8 High Pressure Homogenizer.

### Example 3

In this example, polydimethyl siloxane was emulsified in water, using surfactants as emulsifiers. Two liquids were fed into the apparatus 100, each through a separate inlet. The first liquid was an oily composition of polydimethyl siloxane. The second liquid was an emulsifier composition in water. The final composition produced was 60% polydimethyl siloxane, 34% water and 6% emulsifier. The emulsifier was made of a mixture of 60% Tergitol® 15S-12 (a Polyglycol ether (nonionic) surfactant available from Dow Chemical Company) and 40% Tergitol® 15S-5 (a non-ionic secondary alcohol ethoxylate available from Dow Chemical Company).

The same composition was fed into a Sonolator® 8 High Pressure Homogenizer, again as two separate feeds. The orifice in the Sonolator was 0.35 mm².

The apparatus 100 was used with an operating pressure of 5 bar, whilst the Sonolator® 8 High Pressure Homogenizer was used at an operating pressure of 200 bar. Operating pressures were measured using an Ashcroft pressure meter using standard techniques known in the art.

The apparatus 100 was configured with 5 orifice plates, each plate spaced 6 mm from the neighbouring orifice plate. Each plate comprised one circular orifice having a diameter of 1.9 mm. The orifices were aligned with each other along the centre-line 27 of the apparatus 100.

TABLE 3

| | | Particle size with 90% of |
|---|---|---|
| | Operating Pressure | distribution below |
| Sonolator 8 | 200 bar | 10.06 μm |
| Apparatus 100 | 5 bar | 3.58 μm |

One part of the sample was diluted with 100 parts of de-ionized water and then Particle Size Measurement was carried out using a Malvern S, (Static Light Scattering Particle Distribution Analyzer) using a standard Malvern S measuring cell.

As can be seen from Table 3, at 5 bar operating pressure, the apparatus 100 achieved 90% of the particle population have a size below 3.58 μm. However, even at 200 bar operating pressure, the Sonolator 8 only achieved 90% of the particle population having a size below only 10.06 μm.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

What is claimed is:

1. An apparatus for mixing liquids by producing shear, turbulence and/or cavitation, said apparatus comprising:
at least one inlet;
a pre-mixing chamber, the pre-mixing chamber having an upstream end and a downstream end, the upstream end of the pre-mixing chamber being in liquid communication with the at least one inlet;
an orifice component, the orifice component having an upstream end and a downstream end, the upstream end of the orifice component being in liquid communication with the downstream end of the pre-mixing chamber, wherein the orifice component is configured to spray liquid in a jet and produce shear, turbulence and/or cavitation in the liquid;
a secondary mixing chamber, the secondary mixing chamber being in liquid communication with the downstream end of the orifice component;
at least one outlet in liquid communication with the secondary mixing chamber for discharge of liquid following the production of shear, turbulence and/or cavitation in the liquid, the at least one outlet being located at the downstream end of the secondary mixing chamber;
wherein;
the orifice component comprises at least two orifice units and arranged in series to one another;
wherein each orifice unit comprises an orifice plate comprising at least one orifice, an orifice chamber located upstream from the orifice plate and in liquid communication with the orifice plate;
and wherein neighbouring orifice plates are distinct from each other.

2. The apparatus of claim 1 wherein, each orifice unit further comprises an orifice bracket located adjacent to and upstream from the orifice plate, the walls of the orifice bracket defining a passageway through the orifice chamber.

3. The apparatus of claim 1 wherein, the distance between any two neighbouring orifice plates is equal to or greater than 1 mm.

4. The apparatus of claim 1 wherein, the apparatus further comprises a second inlet.

5. The apparatus of claim 1 wherein, the orifice plate is hinged so that it can rotate 90° about its central axis.

6. The apparatus of claim 1 wherein, the apparatus further comprises a blade.

7. A process for mixing liquids by producing shear, turbulence and/or cavitation, using the apparatus of claim 1, comprising the steps of;
introducing at least one liquid to the inlet of the apparatus at an operating pressure of between about 0.1 bar and about 50 bar;
allowing the liquid to pass through the apparatus;
discharging the liquid following the production of shear or cavitation in the liquid out of the outlet.

8. The process of claim 7 wherein, the operating pressure is between about 0.25 bar and about 20 bar.

9. The process of claim 8 wherein, the operating pressure is between about 0.5 bar and about 10 bar.
